(19) United States
(12) Patent Application Publication
(10) Pub. No.: US 2021/0339683 A1
(43) Pub. Date: Nov. 4, 2021

(54) Document Display Holder for Motor Vehicles

(71) Applicant: Suk Young Kang, Chantilly, VA (US)

(72) Inventor: Suk Young Kang, Chantilly, VA (US)

(21) Appl. No.: 17/244,639

(22) Filed: Apr. 29, 2021

Related U.S. Application Data
(60) Provisional application No. 63/017,893, filed on Apr. 30, 2020.

(51) Int. Cl. B60R 11/00

(52) U.S. Cl. CPC B60R 11/00; B60R 2011/0026; B60R 2011/0056

(57) ABSTRACT

The document display holder is intended to provide users with a device that can hold and display a business card and/or memo for motored vehicles on the vehicle's windshield, to ensure effective communication between the vehicle driver and the general public. To accomplish this, the device includes a rectangular frame made of a clear rigid material, wherein a slot is provided within for placing the business card or any memo. The device further comprises one or more fasteners for mounting onto a windshield or any smooth surface with a lasting hold. Thus, relevant contact information may be displayed from inside of the vehicle for easy visibility and swift contact in case of an emergency. Furthermore, the display holder is versatile and customizable, wherein any information ideal for companies and government entities with fleet vehicles, traveling businessmen, and/or other vehicle related ventures may be displayed.

The current application claims a priority to the U.S. Provisional Patent application Ser. No. 63/017,893 filed on Apr. 30, 2020.

### FIELD OF THE INVENTION

The present invention relates generally to a display holder. More specifically, the present invention is a memo and/or business card display holder for motor vehicles.

### BACKGROUND OF THE INVENTION

In present times, a simple parking lot can quickly turn into a pool of confusion and chaos when parking space is limited. In such situations, when vehicles need to be moved around, contacting vehicle drivers is vital to maintaining normal operations. Currently, vehicle owners have no simple way to communicate with each other and the general public, other than haphazardly scribbling their contact info or message on a piece of paper. Thus, a device that can display a vehicle owner/driver's business card or any custom memo that they want to convey to others, is a rare find in the current market.

An objective of the present invention is to provide users with a device that can hold and display a business card and/or memo for motored vehicles. It is an aim of the present invention to display a business card or other memos on a vehicle's windshield to ensure effective communication between the vehicle driver and the general public. According to the present invention, the device comprises a rectangular frame made of a clear rigid material, wherein a slot is provided within, for placing the business card or any memo. The present invention further comprises one or more fasteners for mounting the device onto a windshield or any smooth surface with a lasting hold. Accordingly, the present invention is an excellent solution for displaying relevant contact information from inside of the vehicle for easy visibility and swift contact in case of an emergency. Furthermore, the present invention is versatile and customizable, wherein any information ideal for companies and government entities with fleet vehicles, traveling businessmen, and/or other vehicle related ventures may be displayed. Thus, the present invention is an ideal accessory for any vehicle, which can ensure effective communication between the vehicle owner/driver and the general public.

### BRIEF DESCRIPTION OF THE DRAWINGS

FIG. 1 is a top-front-right perspective view of the present invention.

FIG. 2 is a top-rear-left perspective view of the present invention.

FIG. 3 is a front elevational view of the present invention.

FIG. 4 is a rear elevational view of the present invention.

FIG. 5 is a top plan view of the present invention.

FIG. 6 is a bottom plan view of the present invention.

FIG. 7 is a right-side elevational view of the present invention.

FIG. 8 is a left-side elevational view of the present invention.

### DETAIL DESCRIPTIONS OF THE INVENTION

All illustrations of the drawings are for the purpose of describing selected versions of the present invention and are not intended to limit the scope of the present invention.

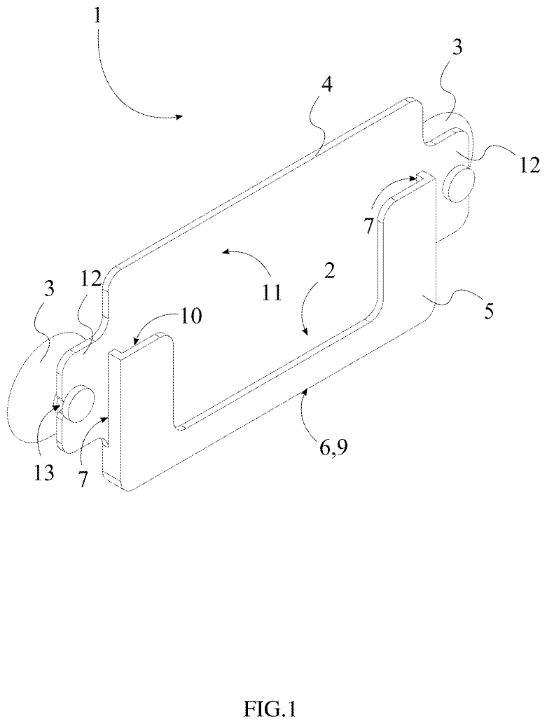

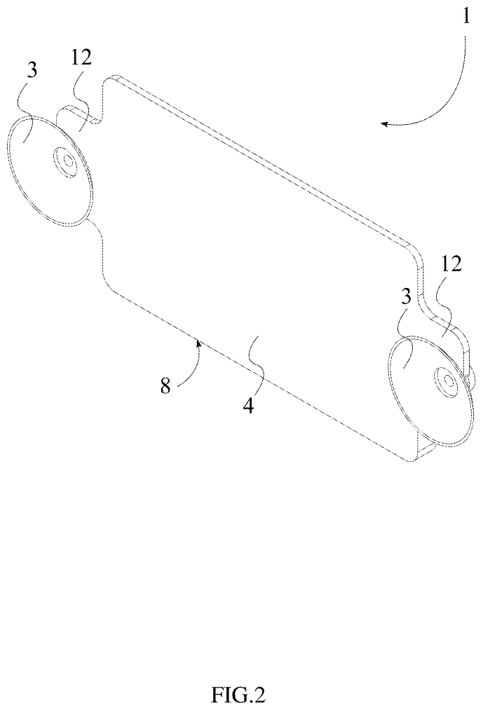

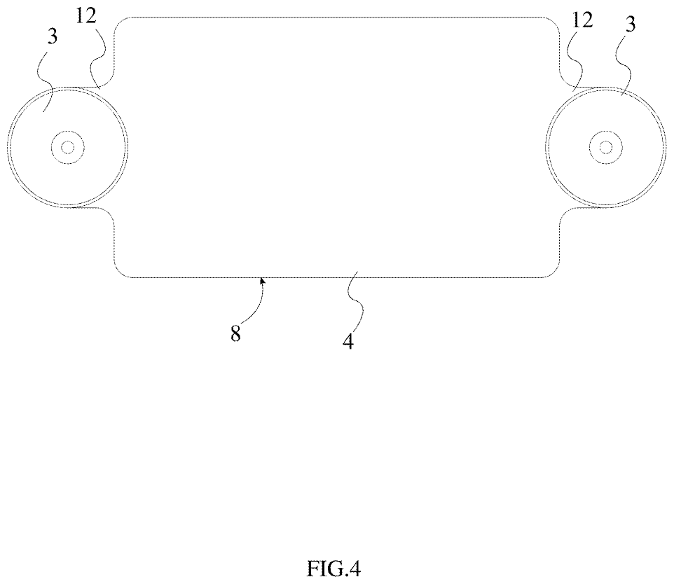

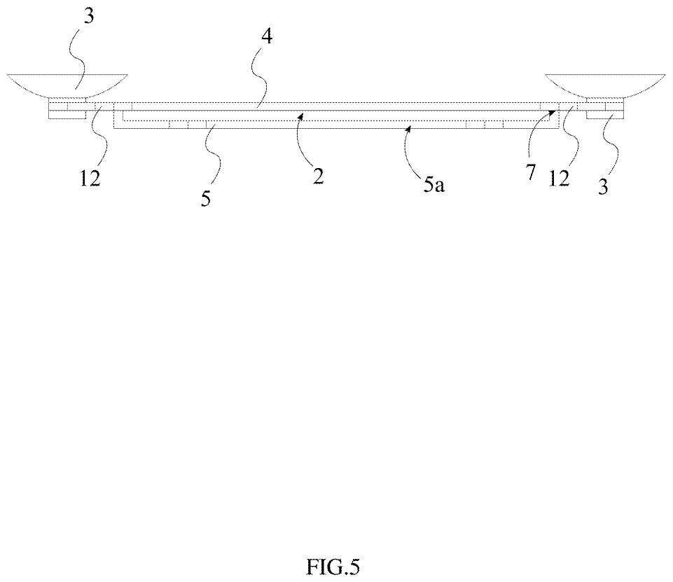

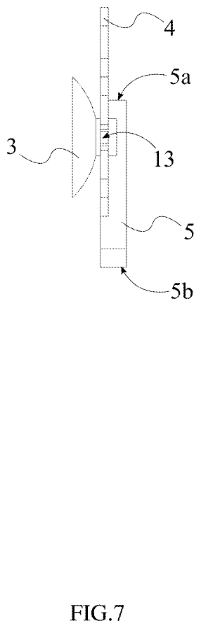

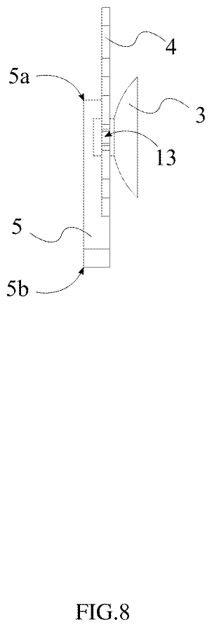

In reference to FIG. 1 through FIG. 8, the present invention is a document display holder. An objective of the present invention is to provide users with a device that can hold and display a business card and/or memo for motored vehicles. It is an aim of the present invention to display a business card or other memos on a vehicle's windshield to ensure effective communication between the vehicle driver and the general public. According to the present invention, the device comprises a rectangular frame made of a clear rigid material, wherein a slot is provided within for placing the business card or any memo. The present invention further comprises one or more fasteners for mounting the device onto a windshield or any smooth surface with a lasting hold. Accordingly, the present invention is an excellent solution for displaying relevant contact information from inside of the vehicle for easy visibility and swift contact in case of an emergency. Furthermore, the present invention is versatile and customizable, wherein any information ideal for companies and government entities with fleet vehicles, traveling businessmen, and/or other vehicle related ventures may be displayed. Thus, the present invention is an ideal accessory for any vehicle, which can ensure effective communication between the vehicle owner/driver and the general public.

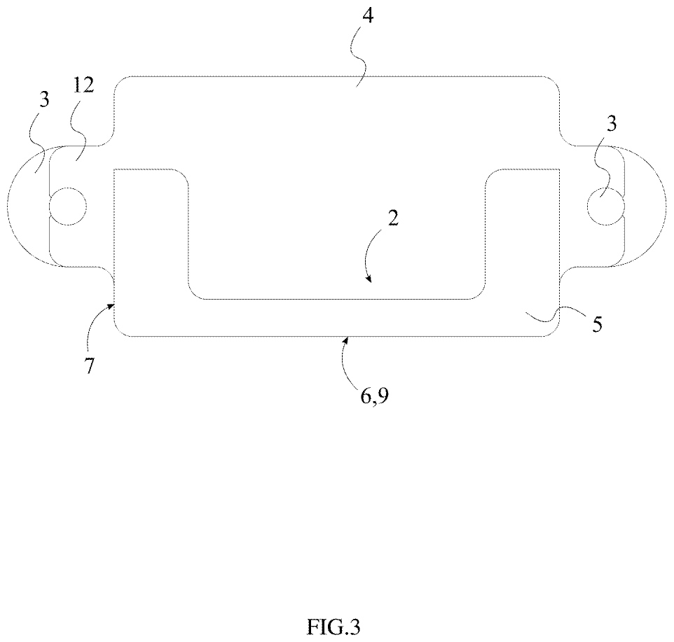

The following description is in reference to FIG. 1 through FIG. 8. According to a preferred embodiment, the present invention comprises a frame 1, a slot 2, and at least one fastener 3. The frame 1 can be of any shape, size, material, features, type or kind, orientation, components, and arrangements of components that would allow the present invention to fulfill the objectives and intents of the present invention. However, preferably, the frame 1 is rectangular in shape and comprises a transparent material such as clear acrylic. Further, the frame 1 comprises a display surface 4 and a holding attachment 5. Preferably, the holding attachment 5 is mounted onto the display surface 4 and the slot 2 traverses into the frame 1 between the display surface 4 and the holding attachment 5. In other words, the display surface 4 constitutes a front surface of the frame 1 and the holding attachment 5 constitutes a rear surface of the frame 1. As seen in FIG. 1 and FIG. 3, the holding attachment 5 comprises an extended U-shape or is a U-shaped attachment (comprising the same frame material), which is attached to a lower end of the display surface 4, thereby forming a part of the frame 1. However, the holding attachment 5 may be formed of materials comprising any shape, size, component or arrangement of components, that do not hinder the intended purpose of the present invention. It is preferred that the display surface 4 is transparent and rectangular in shape. Further, according to the preferred embodiment, the display surface 4 of the frame 1 will face the clear windshield of a motor vehicle, such that the document placed within the slot 2 will be clearly visible to anyone standing outside the vehicle.

In order to efficiently mount the frame 1 onto the windshield of a vehicle, the at least one fastener 3 is perimetrically mounted onto the frame 1. Preferably, the at least one fastener 3 is a suction cup. However, the at least one fastener 3 may comprise any other fastener, fastening technique, shape, size, material, features, type or kind etc., that would allow the present invention to fulfill the objectives and intents of the present invention. Examples of such fasteners include, but are not limited to adhesives, hook and loop fasteners, snap clips, magnetic fasteners etc.

A more detailed description of the components of the present invention follows. As seen in FIG. 1, at least one edge 6 from a plurality of terminal edges 7 of the holding attachment 5 is mounted onto the display surface 4, such that the display surface 4 and the plurality of terminal edges 7 delineate the slot 2. In other words, the slot 2 is created as the holding attachment 5 is connected to the display surface 4 along the holding attachment's 5 terminal edges. To that end, a first terminal edge 8 of the display surface 4 is connected to a second terminal edge 9 of the holding attachment 5, wherein the second terminal edge 9 is from the plurality of terminal edges 7. Further, as seen in FIG. 1 and

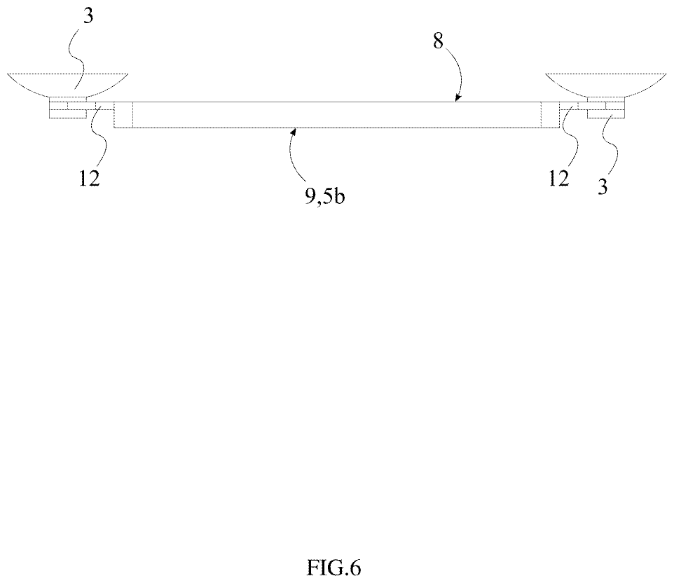

FIG. 6, the first terminal edge 8 and the second terminal edge 9 together create a seamless base for the frame 1.

In the preferred embodiment, the business card or document to be displayed will rest within the slot 2 and the holding attachment 5 ensures that the document remains within the slot 2 of the frame 1. To accomplish this a first planar surface 10 of the holding attachment 5 is oriented parallelly to a second planar surface 11 of the display surface 4, such that the first planar surface 10 acts as the supporting wall/resting surface for the document. Furthermore, the slot 2 extends from a first end 5a of the holding attachment towards a second end 5b of the holding attachment, wherein the first end 5a is positioned opposite to the second end 5b across the holding attachment 5. This arrangement enables to provide any document placed within the slot 2 the necessary support as well as accessibility to the user for easily removing/replacing the document from the slot 2.

As seen in FIG. 1 through FIG. 8, the present invention comprises at least one fastener mount 12, wherein the at least one fastener mount 12 laterally extends from the display surface 4. Preferably, the at least one fastener 3 is mounted onto the at least one fastener mount 12. As seen in FIG. 1, the at least one fastener mount 12 comprises at least one mounting aperture 13, such that the at least on fastener 3 may be hooked onto, hung onto or attached onto the fastener mount 12 through the at least one mounting aperture 13. Preferably, the at least one mounting aperture 13 is a small incision that traverses through the at least one fastener mount 12 and extends across a terminal edge of each of the at least one fastener mount 12. However, it should be noted that the at least one fastener mount 12 and the at least one mounting aperture 13 may comprise any other shape, size, location, orientation, components and arrangement of components, as long as the intents of the present invention are not altered.

Although the invention has been explained in relation to its preferred embodiment, it is to be understood that many other possible modifications and variations can be made without departing from the spirit and scope of the invention as hereinafter claimed.

What is claimed is:

1. A document display device comprising:
a frame;
a slot;
at least one fastener;
the frame comprising a display surface and a holding attachment;
the holding attachment being mounted onto the display surface;
the slot traversing into the frame between the display surface and the holding attachment; and
the at least one fastener being perimetrically mounted onto the frame.

2. The document display device of claim 1, comprising:
at least one edge from a plurality of terminal edges of the holding attachment being mounted onto the display surface, such that the display surface and the plurality of terminal edges delineate the slot.

3. The document display device of claim 2, comprising:
a first terminal edge of the display surface being connected to a second terminal edge of the holding attachment, wherein the second terminal edge is from the plurality of terminal edges; and
the first terminal edge and the second terminal edge together creating a seamless base of the frame.

4. The document display device of claim 1 comprising:
a first planar surface of the holding attachment being oriented parallelly to a second planar surface of the display surface.

5. The document display device of claim 1 comprising:
at least one fastener mount; and
the at least one fastener mount laterally extending from the display surface.

6. The document display device of claim 5, wherein the at least one fastener being mounted onto the at least one fastener mount.

7. The document display device of claim 5, wherein the at least one fastener mount comprising at least one mounting aperture.

8. The document display device of claim 1, wherein the display surface being transparent.

9. The document display device of claim 1, wherein the frame being rectangular.

10. The document display device of claim 1, wherein the at least one fastener being a suction cup.

11. The document display device of claim 1, comprising:
the slot extending from a first end of the holding attachment towards a second end of the holding attachment, wherein the first end is positioned opposite to the second end across the holding attachment.

12. The document display device of claim 1, wherein the holding attachment comprising an extended U shape.

13. A document display device comprising:
a frame;
a slot;
at least one fastener;
at least one fastener mount;
the frame comprising a display surface and a holding attachment;
the holding attachment being mounted onto the display surface;
the slot traversing into the frame between the display surface and the holding attachment;
the at least one fastener being perimetrically mounted onto the frame. the at least one fastener mount laterally extending from the display surface; and
the at least one fastener being mounted onto the at least one fastener mount.

14. The document display device of claim 13, comprising:
at least one edge from a plurality of terminal edges of the holding attachment being mounted onto the display surface, such that the display surface and the plurality of terminal edges delineate the slot;
a first terminal edge of the display surface being connected to a second terminal edge of the holding attachment, wherein the second terminal edge is from the plurality of terminal edges; and
the first terminal edge and the second terminal edge together creating a seamless base of the frame.

15. The document display device of claim 13, comprising:
a first planar surface of the holding attachment being oriented parallelly to a second planar surface of the display surface.

16. The document display device of claim 13, wherein the at least one fastener mount comprising at least one mounting aperture.

17. The document display device of claim 13, wherein the display surface being transparent.

18. The document display device of claim 13, wherein the frame being rectangular.

19. The document display device of claim 13, wherein the at least one fastener being a suction cup.

20. The document display device of claim 13, wherein the holding attachment comprising an extended U shape.
